(19) United States
(12) Patent Application Publication
(10) Pub. No.: US 2023/0022043 A1
(43) Pub. Date: Jan. 26, 2023

(54) Back Massage and Sleep Aid Device

(71) Applicant: Tyler Clark, Hermosa Beach, CA (US)

(72) Inventor: Tyler Clark, Hermosa Beach, CA (US)

(21) Appl. No.: 17/872,074

(22) Filed: Jul. 25, 2022

Related U.S. Application Data
(60) Provisional application No. 63/225,147, filed on Jul. 23, 2021.

(51) Int. Cl. A61H 7/00

(52) U.S. Cl. CPC A61H 7/004; A61H 2201/1671; A61H 2205/081; A61H 2023/0281

(57) ABSTRACT

The present invention relates to a novel back massage device. The device is designed to enable users to lay down and relax while getting a massage. The device comprises a multipurpose, battery operated or plug-in massage component that massages a user's back with ease. The massage component comprises several revolving massage heads that rotate along the back area offering a massage and relaxation. The device comprises a support base with an extending vertical pole that supports the massage component. Thus, users can lay down on their stomach while on a bed or sofa and obtain a hands-free, automated massage.

### CROSS-REFERENCE TO RELATED APPLICATION

The present application claims priority to, and the benefit of, U.S. Provisional Application No. 63/225,147, which was filed on Jul. 23, 2021, and is incorporated herein by reference in its entirety.

### FIELD OF THE INVENTION

The present invention relates generally to the field of back massage devices. More specifically, the present invention relates to an improved back massage device that provides users with an automated massage tool capable of easily and conveniently massaging a user's back. Accordingly, the present disclosure makes specific reference thereto. Nonetheless, it is to be appreciated that aspects of the present invention are also equally applicable to other like applications, devices, and methods of manufacture.

### BACKGROUND

By way of background, massage involves the manipulation of muscle and connective tissue to enhance the function of those tissues and promote relaxation and well-being. Therapeutic massage can ease tension and reduce pain and can also be highly effective for reducing the symptoms of arthritis, back pain, and other disorders of the muscles and/or nervous system. Massage is generally administered either by another person (such as, for example, a masseuse or a masseur) or is self-administered by means of a mechanical massaging device.

Thus, it is necessary for users in need of a massage to find a masseuse/masseur or utilize a handheld device when wanting a massage. Accordingly, the back massage device of the present invention allows a user to save money on repeat massage therapist visits, as well as manually applied massage tools by providing an automated massage device that massages a user's back with ease.

Therefore, there exists a long-felt need in the art for a back massage device that provides users with an automated massage tool capable of easily and conveniently massaging the back. There is also a long-felt need in the art for a back massage device that prevents users from having to spend considerable money on repeat massage therapist visits to obtain pain relief. Further, there is a long-felt need in the art for a back massage device that features a battery-operated or plug-in motor to activate the revolving massage heads, allowing them to rotate along a user's back or other hard-to-reach areas. Moreover, there is a long-felt need in the art for a device that eliminates the need to manually apply a massage tool. Further, there is a long-felt need in the art for a back massage device that allows a user to lay down on their stomach and obtain a hands-free, automated massage. Finally, there is a long-felt need in the art for a back massage device that massages a user's back with ease.

The subject matter disclosed and claimed herein, in one embodiment thereof, comprises a back massage device. The device is designed to enable users to lay down and relax while getting a massage. The device comprises a multipurpose, battery operated or plug-in massage component that massages a user's back with ease. The massage component comprises several revolving massage heads that rotate along the back area offering a massage and relaxation. The device comprises a support base with an extending vertical pole that supports the massage component. Thus, users can lay down on their stomach while on a bed or sofa and obtain a hands-free, automated massage.

In this manner, the back massage device of the present invention accomplishes all of the foregoing objectives and provides users with a device that eliminates the need to manually apply a massage tool. The device allows a user to easily massage their back and other hard-to-reach areas without going to a massage therapist. The device saves time and effort and allows a user to lay down and relax while getting a hands-free massage.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a back massage device. The device is designed to enable users to lay down and relax while getting a massage. The device comprises a multipurpose, battery operated or plug-in massage component that massages a user's back with ease. The massage component comprises several revolving massage heads that rotate along the back area offering a massage and relaxation. The device comprises a support base with an extending vertical pole that supports the massage component. Thus, users can lay down on their stomach while on a bed or sofa and obtain a hands-free, automated massage.

This invention relates to improvements in back massage devices which are used to massage a user's back with ease. Standard household massage tools require manual application to the body. However, it can be difficult to massage the back independently. Users may contort their body in an awkward position to try and massage the back, ultimately causing more aches and pains. Further, paying for a massage therapist can be incredibly expensive and not sustainable for users who constantly need a massage to relax.

The subject matter disclosed and claimed herein, in one embodiment thereof, comprises a back massage device. The device is designed to enable users to lay down and relax while getting a massage. The device comprises a multipurpose, battery operated or plug-in massage component that massages a user's back with ease. The massage component comprises several revolving massage heads that rotate along the back area offering a massage and relaxation. The device comprises a support base with an extending vertical pole that supports the massage component. Thus, users can lay down on their stomach while on a bed or sofa and obtain a hands-free, automated massage.

In one embodiment, the back massage device comprises a massage component having a top and a bottom, as well as a first set of front and back opposing sides and a second set of left and right opposing sides. Typically, the massage component is shaped in an oval or rectangular shape but can be any other suitable shape as is known in the art, depending on the needs and/or wants of a user. Further, the massage component can be any suitable shape and size as is known in the art, as long as a substantial area of a user's back or other hard-to-reach area can be contacted by the device.

In another embodiment, the massage component houses a source of electrical power, such as a battery or electrical power source, and a plurality of rotatable massage heads. If a battery is utilized, it is preferably a rechargeable battery, such as a nickel-cadmium battery, which may, for example, provide a DC operating voltage of 2.4 volts, or any other suitable rechargeable battery as is known in the art. If a battery is not utilized, the electrical power source allows the device to be plugged into a standard wall outlet for power.

Furthermore, the battery and/or electrical power source supplies power to a motor and a pair of eccentric weights which are substantially identical with one another. The weights are mounted in communication with the motor within the massage component, such that the weights rotate in unison about the motor so as to impart a vibratory motion to the plurality of rotating massage heads connected to the massage component. The large mass of the motor and the design of the weights rotating about the motor yield an extremely efficient coupling of the energy generated by the motor with extremely low losses as a result of the mounting of the motor directly in the massage component. It may be appreciated that the motor itself, being centrally disposed within the rotating weights, becomes a vibratory imparting mass, so as to further enhance the operating characteristics of the back massage device.

In another embodiment, the massage component comprises a switch connected in series with a resistor on the motor, for adjusting the speed of the motor from low to high. In this embodiment, the massage component also comprises a power switch for turning the device off and on.

In another embodiment, the massage component comprises a plurality of heating elements in communication with the battery and/or electrical power source. The plurality of heating elements are typically positioned in between the plurality of rotating massage heads, but can be positioned in any suitable position on the massage component as is known in the art. Any suitable number of heating elements can be provided as well, depending on the needs and/or wants of a user. In another embodiment, the massage component comprises a first switch for turning off and on the plurality of heating elements and a second switch for adjusting the heat of the heating elements from low to high.

In yet another embodiment, the massage component comprises a plurality of rotating and/or revolving massage heads. Any suitable number of massage heads can be utilized, depending on the needs and/or wants of a user. The massage heads can be sized and shaped as standard massage heads and are in communication with the motor. The motor and the eccentric weights which rotate in unison about the motor impart a vibratory motion to the plurality of rotating and/or revolving massage heads connected to the massage component. Further, the switch which adjusts the speed of the motor from low to high, allows for the massage heads to rotate and/or vibrate at a high speed or a low speed, depending on the needs and/or wants of a user.

In one embodiment, the massage component is secured to an extending vertical pole component. The vertical pole component can be any suitable size and shape as is known in the art. Further, the vertical pole component can be comprised of a flexible but rigid material that allows a user to bend the massage component in a suitable position during use. In another embodiment, the vertical pole component is telescoping and allows a user to extend the vertical pole component to a desired height. The vertical pole component comprises a first extending component that is slid within a second extending component, each comprising a plurality of coordinating openings at different heights along the first and second extending components. A pin or other suitable component fits within the plurality of coordinating openings, securing the vertical pole component at a desired height above the user's back.

In one embodiment, the extending vertical pole component is secured to a base component. The base component can be any suitable shape and size as is known in the art, depending on the needs and/or wants of a user, as long as the base component is large enough to hold up the massage component without tipping over. Further, in one embodiment, the base component is weighted to further secure the device in an upright position over a user's back or other hard-to-reach area.

In one embodiment, the back massage device is manufactured of a metal, heat-sealable plastic, or polymer, such as polypropylene or acrylonitrile-butadiene-styrene (ABS), etc., or any other suitable material as is known in the art. In this embodiment, the back massage device is also manufactured of a water-resistant material.

In yet another embodiment, the back massage device comprises a plurality of indicia.

In yet another embodiment, a method of massaging a user's back hands-free is described. The method includes the steps of providing a back massage device that rotates along a user's back area offering a massage and relaxation. The method also comprises adjusting the vertical pole of the device to the desired height, such that the massaging component of the device contacts a user's back. Further, the method comprises, once in position, turning on the back massage device such that the rotating massage heads begin to rotate. The method also comprises, positioning a user on their stomach, such that their back contacts the rotating massage heads. Finally, massaging a user for a desired period of time hands-free.

In yet another embodiment of the present invention, a back massage device is disclosed for massaging a user's hard-to-reach areas hands-free. The device comprises a massage component, comprising a plurality of rotating heads that rotate and vibrate along a user's back area offering a massage and relaxation. The massage component is secured to a vertical pole component which is then secured to a base component. The base component retains the device in an upright position and the vertical pole allows the massage component to be positioned over a user's back area. The device can be plugged-in to an electrical outlet or battery operated. Once in position, users lay down on their stomach while on a bed or sofa to obtain a hands-free, automated massage.

In this manner, the back massage device of the present invention accomplishes all of the foregoing objectives and provides users with a device that eliminates the need to manually apply a massage tool. The device allows a user to easily massage their back and other hard-to-reach areas without going to a massage therapist. The device saves time and effort and allows a user to lay down and relax while getting a hands-free massage.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the back massage device of the present invention in accordance with the disclosed architecture;

FIG. 2 illustrates a perspective view of one potential embodiment of the back massage device of the present invention in use in accordance with the disclosed architecture;

FIG. 3 illustrates a perspective view of one potential embodiment of the back massage device of the present invention, wherein the rotating massage heads are massaging a user's back in accordance with the disclosed architecture;

FIG. 4 illustrates a perspective view of one potential embodiment of the back massage device of the present invention with the heat elements in use in accordance with the disclosed architecture;

FIG. 5 illustrates a perspective view of one potential embodiment of the back massage device of the present invention with an electrical plug in accordance with the disclosed architecture; and

FIG. 6 illustrates a flowchart showing the method of massaging a user's back hands-free using one potential embodiment of the back massage device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a back massage device that provides users with an automated massage tool capable of easily and conveniently massaging the back. There is also a long-felt need in the art for a back massage device that prevents users from having to spend considerable money on repeat massage therapist visits to obtain pain relief. Further, there is a long-felt need in the art for a back massage device that features a battery-operated or plug-in motor to activate the revolving massage heads, allowing them to rotate along a user's back or other hard-to-reach areas. Moreover, there is a long-felt need in the art for a device that eliminates the need to manually apply a massage tool. Further, there is a long-felt need in the art for a back massage device that allows a user to lay down on their stomach and obtain a hands-free, automated massage. Finally, there is a long-felt need in the art for a back massage device that massages a user's back with ease.

The present invention, in one exemplary embodiment, is a novel back massage device. The device is designed to enable users to lay down and relax while getting a massage. The device comprises a multipurpose, battery operated or plug-in massage component that massages a user's back. The massage component comprises several revolving massage heads that rotate along the back area offering a massage and relaxation. The device comprises a support base with an extending vertical pole that supports the massage component. Thus, users can lay down on their stomach while on a bed or sofa and obtain a hands-free, automated massage. The present invention also includes a novel method of massaging a user's back hands-free. The method includes the steps of providing a back massage device that rotates along a user's back area offering a massage and relaxation. The method also comprises adjusting the vertical pole of the device to the desired height, such that the massaging component of the device contacts a user's back. Further, the method comprises, once in position, turning on the back massage device such that the rotating massage heads begin to rotate. The method also comprises, positioning a user on their stomach, such that their back contacts the rotating massage heads. Finally, massaging a user for a desired period of time hands-free.

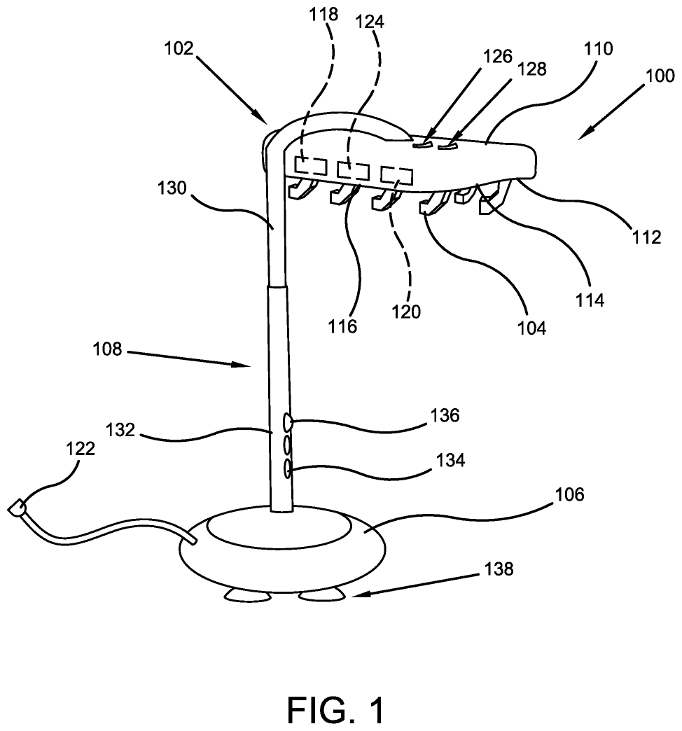

Referring initially to the drawings, FIG. 1 illustrates a perspective view of one embodiment of the back massage device 100 of the present invention. In the present embodiment, the back massage device 100 is an improved back massage device that massages a user's back hands-free. The device 100 is especially designed to allow any suitable user as is known in the art, to lay down on their stomach while on a bed, sofa, or other suitable place as is known in the art, to obtain an automated, hands-free massage. More specifically, the device 100 comprises a massage component 102 comprising several revolving/vibrating massage heads 104 that rotate and vibrate along the back area 200 offering a massage and relaxation. The device 100 further comprises a support base 106 with an extending vertical pole 108 that supports the massage component 102.

The back massage device 100 comprises a massage component 102 having a top 110 and a bottom 112, as well as a first set of front and back opposing sides 114 and a second set of left and right opposing sides 116. Typically, the massage component 102 is shaped in an oval or rectangular shape but can be any other suitable shape as is known in the art, depending on the needs and/or wants of a user. Further, the massage component 102 can be any suitable shape and size as is known in the art, as long as a substantial area of a user's back 200 or other hard-to-reach area can be contacted by the device 100. Additionally, the massage component 102 must be large enough to house the plurality of massage heads 104, as well as a motor 118 and other necessary electronics.

Furthermore, the massage component 102 houses a source of electrical power, such as a battery 120 or electrical power source 122, and a plurality of rotatable massage heads 104. If a battery 120 is utilized, it is preferably a rechargeable battery, such as a nickel-cadmium battery, which may, for example, provide a DC operating voltage of 2.4 volts, or any other suitable rechargeable battery as is known in the art. If a battery 120 is not utilized, the electrical power source 122 allows the device 100 to be plugged into a standard wall outlet (not shown) for power. In one embodiment, the device 100 comprises a rechargeable battery 120 and an electrical power source 122, allowing a user to either plug-in the device or use the battery 120 for power, depending on their wants and/or needs.

Additionally, the battery 120 and/or electrical power source 122 supplies power to a motor 118 and a pair of eccentric weights 124 which are substantially identical with one another. The weights 124 are mounted in communication with the motor 118 within the massage component 102, such that the weights 124 rotate in unison about the motor 118 so as to impart a vibratory motion to the plurality of rotating massage heads 104 connected to the massage component 102. The large mass of the motor 118 and the design of the weights 124 rotating about the motor 118 yield an extremely efficient coupling of the energy generated by the motor 118, with extremely low losses as a result of the mounting of the motor 118 directly in the massage component 102. It may be appreciated that the motor 118 itself, being centrally disposed within the rotating weights 124, becomes a vibratory imparting mass, so as to further enhance the operating characteristics of the back massage device 100.

In one embodiment, the massage component 102 comprises a switch 126 connected in series with a resistor (not shown) on the motor 118, for adjusting the speed of the motor 118 from low to high. In this embodiment, the massage component 102 also comprises a power switch 128 for turning the device 100 off and on. Any suitable number of switches can be utilized as is known in the art, depending on the needs and/or wants of a user.

Further, the massage component 102 is secured to an extending vertical pole component 108 via any suitable securing means as is known in the art, such as screws, glue, bolts, etc. The vertical pole component 108 can be any suitable size and shape as is known in the art. Further, the vertical pole component 108 can be comprised of a flexible but rigid material that allows a user to bend the massage component 102 in a suitable position for use. In one embodiment, the material can be layered, wherein the outside material is more flexible, and the inside material is more rigid, allowing the vertical pole component 108 to be bent but still retain its position. In another embodiment, the vertical pole component 108 is telescoping and allows a user to extend the vertical pole component 108 to a desired height. The vertical pole component 108 comprises a first extending component 130 that is slid within a second extending component 132, each comprising a plurality of coordinating openings 134 at different heights along the first and second extending components 130, 132. A pin 136 or other suitable component fits within the plurality of coordinating openings 134, securing the vertical pole component 108 at a desired height above the user's back 200.

Additionally, the extending vertical pole component 108 is secured to a base component 106 via any suitable securing means as is known in the art, such as screws, glue, bolts, etc. The base component 106 can be any suitable shape and size as is known in the art, depending on the needs and/or wants of a user, as long as the base component 106 is large enough to hold up the massage component 102 without tipping over. Further, in one embodiment, the base component 106 is weighted to further secure the device 100 in an upright position over a user's back 200 or other hard-to-reach area. In another embodiment, the bottom of the base component 106 comprises a plurality of suction cups 138. Any suitable number of suction cups 138 can be used as is known in the art, depending on the needs and/or wants of a user. The suction cups 138 allow the base component 106 to be securely attached to a smooth surface, without tipping over.

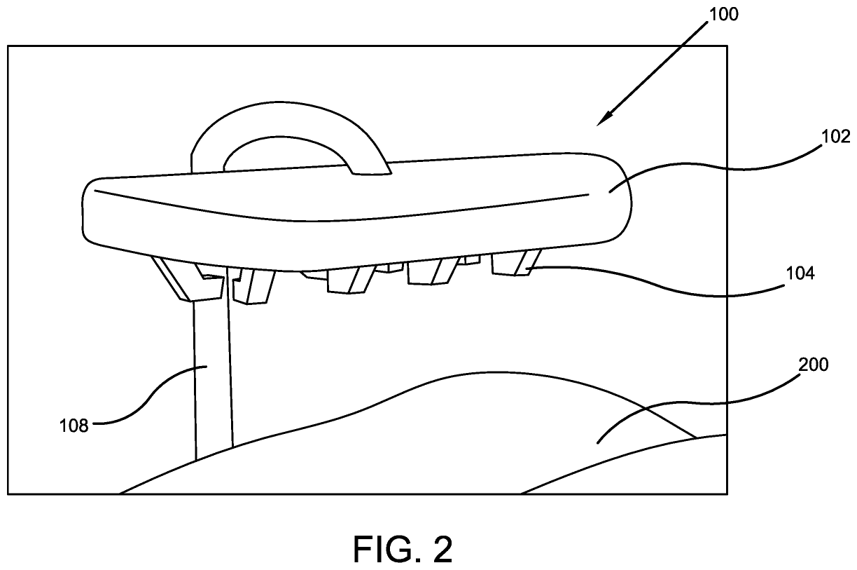

As shown in FIG. 2, the massage component 102 comprises a plurality of rotating and/or revolving massage heads 104. Any suitable number of massage heads 104 can be utilized, depending on the needs and/or wants of a user. The massage heads 104 can be sized and shaped as standard massage heads and are in communication with the motor 118. The motor 118 and the eccentric weights 124 which rotate in unison about the motor 118 impart a vibratory motion to the plurality of rotating and/or revolving massage heads 104 connected to the massage component 102. Further, the switch 126 which adjusts the speed of the motor 118 from low to high, allows for the massage heads 104 to rotate and/or vibrate at a high speed or a low speed, depending on the needs and/or wants of a user. In one embodiment, the motor 118 may have a “light tough” setting in addition to low and high. This setting replicates the light touch of a fingertip massage. In one embodiment, the device 100 may have a plurality of massage heads 104 that can be interchanged by the user. Each massage head 104 will have a different shape, construction, and/or purpose that provides a differing massage experience. More specifically, massage heads 104 for the “light touch” setting may be spring-loaded in order to provide a softer massage experience that gently follows the contours of the body of the user. As a result, this setting aids a user in falling asleep easier and relaxing.

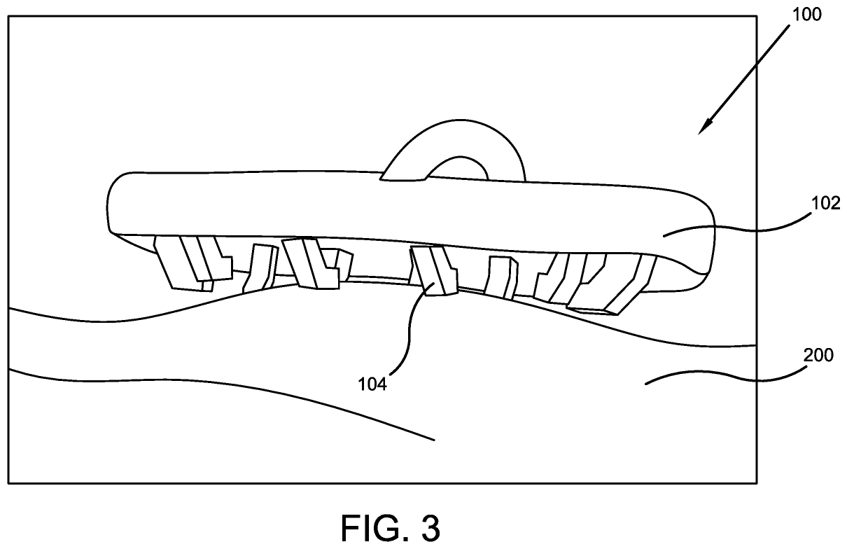

As shown in FIG. 3, the back massage device 100 is shown in use for massaging a user's hard-to-reach areas hands-free. The device 100 comprises a massage component 102 comprising a plurality of rotating heads 104 that rotate and vibrate along a user's back area 200 offering a massage and relaxation. The massage component 102 is secured to a vertical pole component 108 which is then secured to a base component 106. The base component 106 retains the device 100 in an upright position and the vertical pole 108 allows the massage component 102 to be positioned over a user's back area 200. The device 100 can be plugged-in to an electrical outlet or battery operated. Once in position, users lay down on their stomach while on a bed or sofa to obtain a hands-free, automated massage.

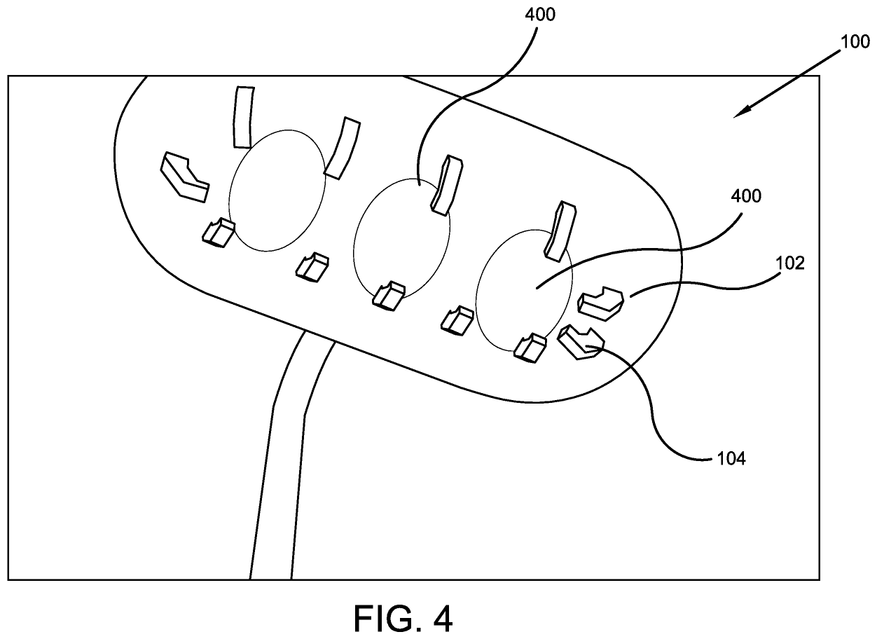

As shown in FIG. 4, the massage component 102 comprises a plurality of heating elements 400 in communication with the battery 120 and/or electrical power source 122. The plurality of heating elements 400 are typically positioned in between the plurality of rotating massage heads 104, but can be positioned in any suitable position on the massage component 102 as is known in the art. Any suitable number of heating elements 400 can be provided as well, depending on the needs and/or wants of a user. In another embodiment, the massage component 102 comprises a first switch 402 for turning off and on the plurality of heating elements 400 and a second switch 404 for adjusting the heat of the heating elements 400 from low to high.

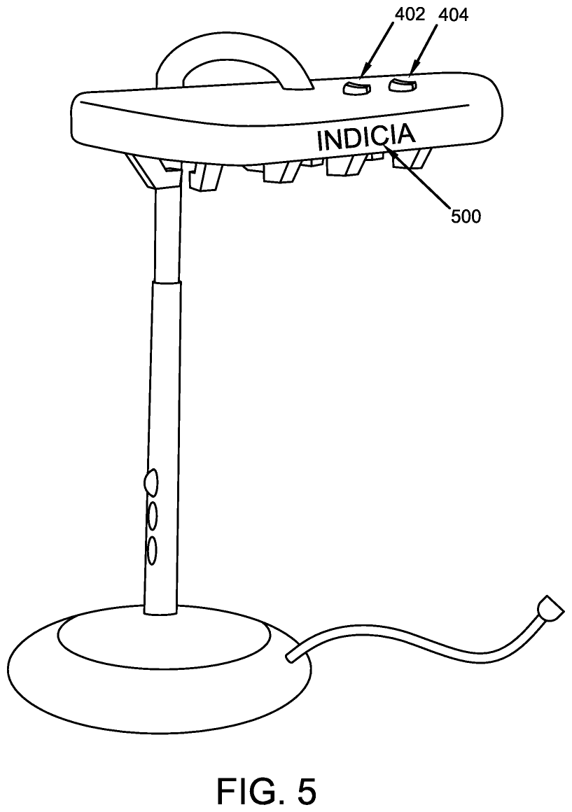

As shown in FIG. 5, the back massage device 100 is manufactured of a metal, heat-sealable plastic or polymer, such as polypropylene or acrylonitrile-butadiene-styrene (ABS), or any other suitable material as is known in the art, such as, but not limited to, acrylic, polycarbonate, polyethylene, thermoplastic, polyethylene terephthalate, polyvinyl chloride, polystyrene, polylactic acid, etc. Generally, the back massage device 100 is also manufactured from a material that is water resistant or water permeable, or comprises a coating that is water resistant or water permeable.

In yet another embodiment, the back massage device comprises a plurality of indicia 500. The massage component 102 of the device 100 may include advertising, a trademark, or other letters, designs, or characters, printed, painted, stamped, or integrated into the device 100, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be massage/brand related.

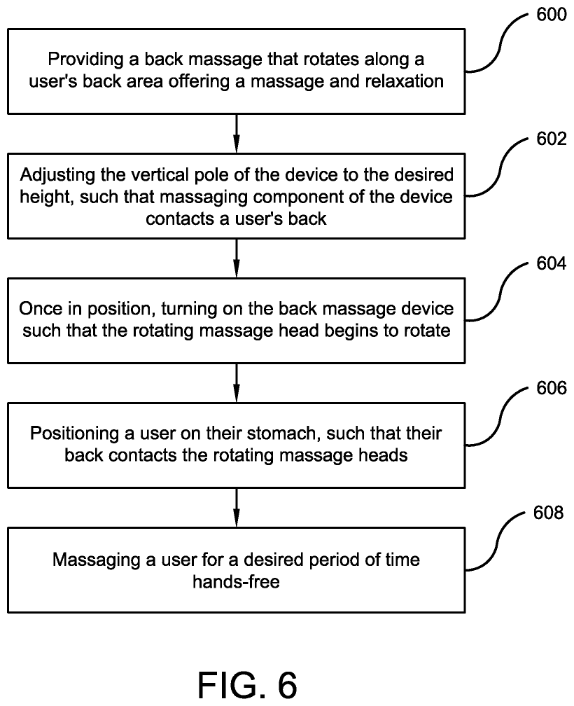

FIG. 6 illustrates a flowchart of the method of massaging a user's back hands-free. The method includes the steps of at 600, providing a back massage device that rotates along a user's back area offering a massage and relaxation. The method also comprises at 602, adjusting the vertical pole of the device to the desired height, such that massaging component of the device contacts a user's back. Further, the method comprises at 604, once in position, turning on the back massage device such that the rotating massage heads begin to rotate. The method also comprises at 606, positioning a user on their stomach, such that their back contacts the rotating massage heads. Finally, at 608, massaging a user for a desired period of time hands-free.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “back massage device”, “massage device”, and “device” are interchangeable and refer to the back massage device 100 of the present invention.

Notwithstanding the foregoing, the back massage device 100 of the present invention can be of any suitable size and configuration as is known in the art without affecting the overall concept of the invention, provided that it accomplishes the above-stated objectives. One of ordinary skill in the art will appreciate that the back massage device 100 as shown in FIGS. 1-6 are for illustrative purposes only, and that many other sizes and shapes of the back massage device 100 are well within the scope of the present disclosure. Although the dimensions of the back massage device 100 are important design parameters for user convenience, the back massage device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A back massage device that massages a user's back hands-free, the back massage device comprising:
a massage component comprising a plurality of rotating massage heads;
a vertical pole component secured to the massage component; and
a base component secured to the vertical pole component;
wherein the base component retains the back massage device in an upright position and the vertical pole component allows the massage component to be positioned over a user's back area; and
further wherein the plurality of rotating massage heads are configured to rotate and vibrate along the user's back area offering a massage and relaxation.

2. The back massage device of claim 1, wherein the massage component comprises a top, a bottom, a first set of front and back opposing sides, and a second set of left and right opposing sides.

3. The back massage device of claim 2, wherein the massage component comprises a rechargeable battery.

4. The back massage device of claim 2, wherein the massage component comprises an electrical power source which is configured to allow the back massage device to be plugged into a standard wall outlet.

5. The back massage device of claim 2, wherein the massage component comprises a rechargeable battery and an electrical power source.

6. The back massage device of claim 5, wherein the rechargeable battery and the electrical power source is configured to supply power to a motor and a pair of eccentric weights.

7. The back massage device of claim 6, wherein the pair of eccentric weights are configured to be mounted in communication with the motor, such that the pair of eccentric weights are configured to rotate in unison about the motor to impart a vibratory motion to the plurality of rotating massage heads.

8. The back massage device of claim 7, wherein the massage component comprises a switch in communication with the motor for adjusting speed of the motor.

9. The back massage device of claim 8, wherein the massage component comprises a power switch.

10. The back massage device of claim 1, wherein the vertical pole component is telescoping and comprises a first extending component that is slid within a second extending component, each comprising a plurality of coordinating openings at different heights along the first and second extending components.

11. The back massage device of claim 10 further comprising a pin that is configured to fit within the plurality of coordinating openings, securing the vertical pole component at a desired height above the user's back.

12. The back massage device of claim 1, wherein the base component is weighted.

13. The back massage device of claim 1, wherein the base component comprises a plurality of suction cups.

14. The back massage device of claim 1 further comprising a plurality of heating elements on the massage component.

15. A back massage device that massages a user's back hands-free, the back massage device comprising:
a massage component comprising a plurality of rotating massage heads and a plurality of heating elements;
a vertical pole component secured to the massage component; and
a base component secured to the vertical pole component;
wherein the massage component comprises a rechargeable battery and an electrical power source which supplies power to a motor and a pair of eccentric weights;
wherein the pair of eccentric weights are mounted in communication with the motor, such that the pair of eccentric weights rotate in unison about the motor to impart a vibratory motion to the plurality of rotating massage heads;
wherein the base component retains the back massage device in an upright position and the vertical pole component allows the massage component to be positioned over a user's back area; and
further wherein the plurality of heating elements apply heat and the plurality of rotating massage heads rotate and vibrate along the user's back area offering a massage and relaxation.

16. The back massage device of claim 15 further comprising a plurality of indicia.

17. The back massage device of claim 15, wherein the vertical pole component is telescoping and comprises a first extending component that is slid within a second extending component, each comprising a plurality of coordinating openings at different heights along the first and second extending components.

18. The back massage device of claim 17 further comprising a pin that fits within the plurality of coordinating openings, securing the vertical pole component at a desired height above a user's back.

19. The back massage device of claim 15, wherein the massage component comprises a switch in communication with the motor for adjusting speed of the motor and a power switch.

20. A method of massaging a user's back hands-free comprising the steps of:
providing a back massage device that rotates along a user's back area offering a massage and relaxation;
adjusting the vertical pole of the device to the desired height, such that massaging component of the device contacts a user's back;
once in position, turning on the back massage device such that the rotating massage heads begin to rotate;
positioning a user on their stomach, such that their back contacts the rotating massage heads; and
massaging a user for a desired period of time hands-free.
